(19) United States
(12) Patent Application Publication
(10) Pub. No.: US 2020/0284572 A1
(43) Pub. Date: Sep. 10, 2020

(54) Method for improving phase stability of phase unstable optical coherence tomography

(71) Applicant: Axsun Technologies, Inc., Billerica, MA (US)

(72) Inventors: Timothy N. Ford, Acton, MA (US); Brian Goldberg, Wellesley, MA (US)

(21) Appl. No.: 16/811,882

(22) Filed: Mar. 6, 2020

Related U.S. Application Data
(60) Provisional application No. 62/814,592, filed on Mar. 6, 2019.

(51) Int. Cl. G01B 9/02

(52) U.S. Cl. CPC G01B 9/02091; G01B 9/0207

(57) ABSTRACT

A system and method for measuring and correcting phase errors in an OCT system.

### RELATED APPLICATIONS

This application claims the benefit under 35 USC 119(e) of U.S. Provisional Application No. 62/814,592, filed on Mar. 6, 2019, which is incorporated herein by reference in its entirety.

### BACKGROUND OF THE INVENTION

Optical coherence tomography (OCT) is an emerging technology for minimally invasive biomedical imaging. One embodiment of Fourier-Domain OCT is swept-source OCT (SS-OCT), sometimes called Optical Fourier Domain Imaging (OFDI), which involves a light source with rapidly changing instantaneous wavelength, an interferometer arrangement which transmits light to and from the sample and mixes it with a reference reflector, and a high-speed optical receiver and detector (see FIG. 1). In this embodiment, for every wavelength sweep of the laser, a time-domain interferogram waveform is created and sampled with a digitizer. Signal processing converts the sampled time-domain vector into a complex-valued reflectivity vs depth vector called an A-line. A set of A-lines collected over time while the sample is scanned is called a B-scan and is typically displayed as an image with a log-magnitude colormap.

### SUMMARY OF THE INVENTION

In general, according to one aspect, the invention features a system and method for measuring and correcting phase errors in an OCT system.

In general according to one aspect, the invention features a method for measuring and correcting phase errors in an OCT system by finding phase stable regions of sweeps and for each sweep of an object, unwrappring the phase vector based on the phase stable regions of the sweeps.

In general according to one aspect, the invention features an optical coherence tomography system, comprising a sample interferometer, a digital acquisition system for digitizing sweeps from the sample interferometer, an image processing computer for taking the sweeps of an object and for each sweep of an object, unwrapping the phase vector based on the phase stable regions of the sweeps.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1: Optical Coherence Tomography basic data collection schematic.

FIG. 2: Fourier transform relationship between spectral interferogram intensity and sample reflectivity. IDFT: inverse discrete Fourier transform. A single frequency component uniformly sampled in wave number k=2π/λ corresponds to a delta function in depth space. A phase offset in spectral interferogram sampling of ϕ_0 results in a complex phase shift e^{∧}(iϕ_0) in depth space.

FIG. 3: Simplified OCT software resampling scheme with k-clock errors. The sweep trigger causes the digitizer to begin sampling the k-clock and sample interferograms for a laser sweep at t=t₀. The sample interferogram is interpolated at time points corresponding to uniform phase transitions of the k-clock spectral interferogram (e.g. at ϕ_{n,m}=2 πm/M for the m^{th} sample of the n^{th} clock). This results in uniform k-sampling in the resampled interferogram. In this example, the naïve phase unwrapping algorithm assigns the k-clock phase at t=t₀ to the range π<ϕ(t₀)<3π for sweep 1 and to the range −π<ϕ(t₀)≤π for sweep 2, resulting in a different portion of the underlying spectral interferogram being sampled and passing to the next step of the signal processing pipeline. The k-sampling shift of one clock FSR results in a phase shift in the A-line result.

FIG. 4: Histogram of k-clock spectral interferogram phase transition times. 4a) aggregate distribution of entire sampled data region. 4b) Zoomed in view of (4a) showing the portion of the sweep with highest phase stability. Here the k-clock FSR of 80 GHz separates the clock transitions. Red, purple, and orange dashes denote the distribution bounds of three consecutive clocks. Non-zero gaps between clock distributions confirms the phase stability of the system is good enough for the phase correction algorithm described in this disclosure.

FIG. 5A-5F: Unwrapped phase vector \hat{ϕ}[n] and phase-corrected \hat{ϕ}′[n]. a) Histogram of \hat{ϕ}[n′] at optimal virtual sweep trigger sample n′. The correct clock number is N_{c}′=178. b) Set of clock integers └\hat{ϕ}[n]+0.5′ for 1024 sweeps showing phase jitter near beginning of sweep. c) Same as (b) but near the optimal virtual sweep trigger sample n′. d) Histogram of \hat{ϕ}′[n′] at optimal virtual sweep trigger sample n′. By construction, the distribution is bounded by \hat{ϕ}′[n′]∈(N_{c}′−0.5, N_{c}′+0.5). e) Same as (b) for phase corrected clock. f) Same as (e) near virtual sweep trigger sample n′.

FIGS. 6A and 6B: a flow diagram showing the method to implement phase-stable background subtraction.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

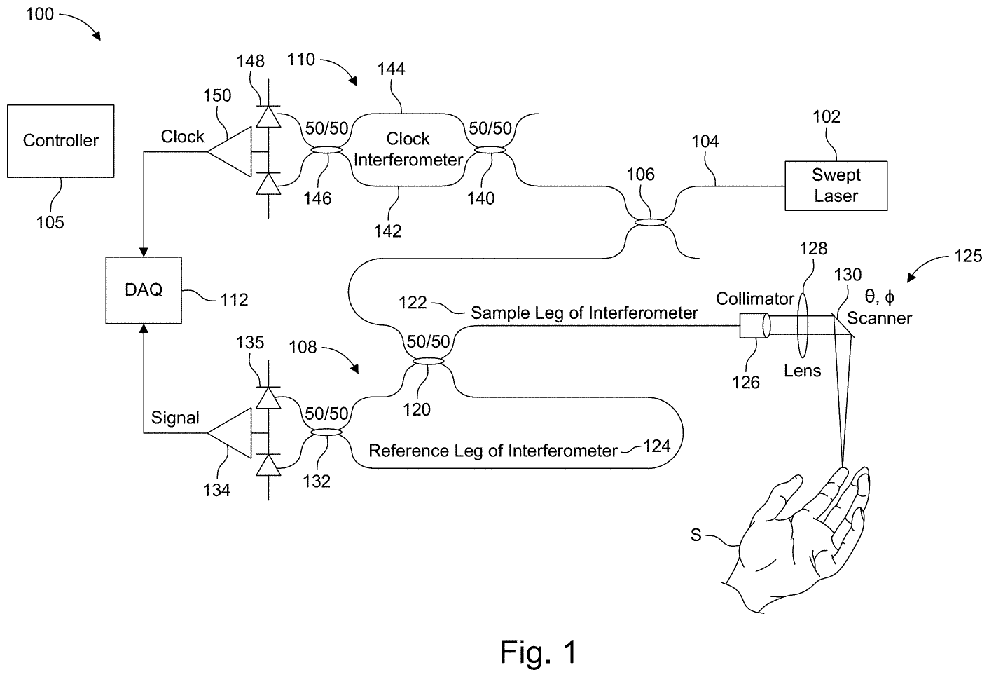

FIG. 1 shows how an OCT system works and specifically of a swept source optical coherence tomography imaging system 100.

That said, many other system configurations are possible, and everything discussed here also applies to spectral domain systems as well as the exemplary swept source system illustrated here.

In general, these systems incorporate an optical probe 125, an interferometer 108 and clocking system 110, and data acquisition 112 and imaging processing computer such as a controller 105 or other computer.

Two types of signal acquisition are envisioned by the methods in this invention. In the first case, clock transitions trigger the sampling of the signal by the data acquisition board (DAQ) 112. This is called direct clocking. In a second scheme, a data acquisition board (DAQ) 112 samples the signal and reference interferometer (i.e. the clock) data at a constant 100 MS/s rate or faster and a computer resamples the signal at uniform optical frequency intervals.

In the illustrated example, the OCT system 100 uses a swept source 102 to generate wavelength swept optical signals on optical fiber 104. The swept source 102 is typically a tunable laser designed for high speed spectral sweeping. The swept optical signals are narrowband emissions that are scanned, or “swept,” over the spectral scan band. Tunable lasers are constructed from a gain element such as a semiconductor optical amplifier (“SOA”) that is located within a resonant laser cavity, and a tuning element such as a rotating grating, a grating with a rotating mirror, or a Fabry-Perot tunable filter. Another common laser is the vertical surface emitting laser (VCSEL). Especially, VCSELs with microelectromechanical system (MEMS) tunable mirrors are especially fast. Tunable lasers are known in the art, such as those described in U.S. Pat. Nos. 7,415,049, 8,526,472, and 10,109,979, which are incorporated herein by reference in their entirety.

A source fiber coupler 106 or other optical splitter divides the swept optical signal from the swept source 102 into a portion that is provided to an OCT interferometer 108 and a portion that is provided to a k-clock module 110. The controller 105 such as a host computer controls the swept source 102 and a data acquisition system (DAQ) 112. The DAQ samples the interference signal and receives the clock signal from the k-clock module 110, either as another analog signal to be sampled at a constant rate, or as a digital clock to trigger sampling of the analog signal at the output of the balanced receiver 134/135.

The interferometer 108 sends optical signals to a sample S, analyzes the optical signals reflected from the sample, and generates an optical interference signal in response.

In the illustrated example, a first interferometer fiber coupler 120 divides the light from the source 102 between a sample leg 122 of the interferometer 108 and a reference leg 124 of the interferometer.

The fiber of sample leg 122 couples to an optical probe 125. The illustrated probe includes collimator 126. A lens 128 focuses the light emitted from the collimator 126 and couples return light back into the sample leg 122 via the collimator 126. Typically, a scanner 130, such as a tip/tilt mirror scanner, controlled by the controller 105 scans the light emitted from the sample leg over the sample to build up a three dimensional volumetric image of the sample S.

Light returning from the sample S on the sample leg 122 is coupled through the first interferometer fiber coupler 120 to a second interferometer fiber coupler 132, which mixes the light from the sample with the light from the reference leg 124.

An interferometer balanced detector system 135 detects the light from the second interferometer fiber coupler 132. This interference signal is amplified by an interferometer amplifier 134 and then sampled by the DAQ 112.

On the other hand, the light from the other leg of the source fiber coupler 106 is provided to the k-clock module 110. The k-clock module 110 generates optical k-clock signals at equally spaced optical frequency sampling intervals as the swept optical signal is tuned or swept over the scan band. The optical k-clock signals are converted into electronic k-clock signals, which are used by the data acquisition system 112 to track the frequency tuning of the optical swept source 102.

The particular illustrated example uses a fiber interferometer that comprises a first clock fiber coupler 140, two fiber legs 142, 144 and a second clock fiber coupler 146. The k-clock light is then detected by clock balanced detector system 148. Its signal is amplified by a clock amplifier 150.

Some Swept Source OCT systems use a hardware-based k-clocking. The k-clock signal is used to directly clock the Analog-to-Digital (“A/D”) converter of the DAQ 112 for sampling the electronic interference signals from the balanced detector 135. An alternative is a software-based k-clocking, wherein the k-clock signals are sampled at a fixed rate in time from the k-clock module 110 in the same manner as the interference signal from the main interferometer 108, creating a k-clock dataset of all sampled k-clock signals and an interference dataset of all sampled interference signals. Then, the k-clock dataset is used to resample the interference dataset. The resampling provides data that are evenly spaced in the optical frequency domain, or k-space.

The specific swept source used had an 825 nanometer (nm) pump laser, 825 nm/1060 nm dichroic filter, optically pumped MEMS tunable VCSEL, 1060 nm isolator, and 1060 nm semiconductor optical amplifier (SOA) all co-packaged in a 14-pin butterfly module. The point-spreads were taken with a variable path-length sample interferometer. The fiber Mach-Zehnder clock interferometer 110 was cut to provide an 8 mm Nyquist depth when direct sampling. The clock interferometer directly triggered sampling in the DAQ. Each point spread curve is the average of 100 separate A-lines at one mirror position.

Although these example data were taken with a VCSEL, the methods apply to any type of swept source. In addition, these methods can be applied to spectral domain OCT systems.

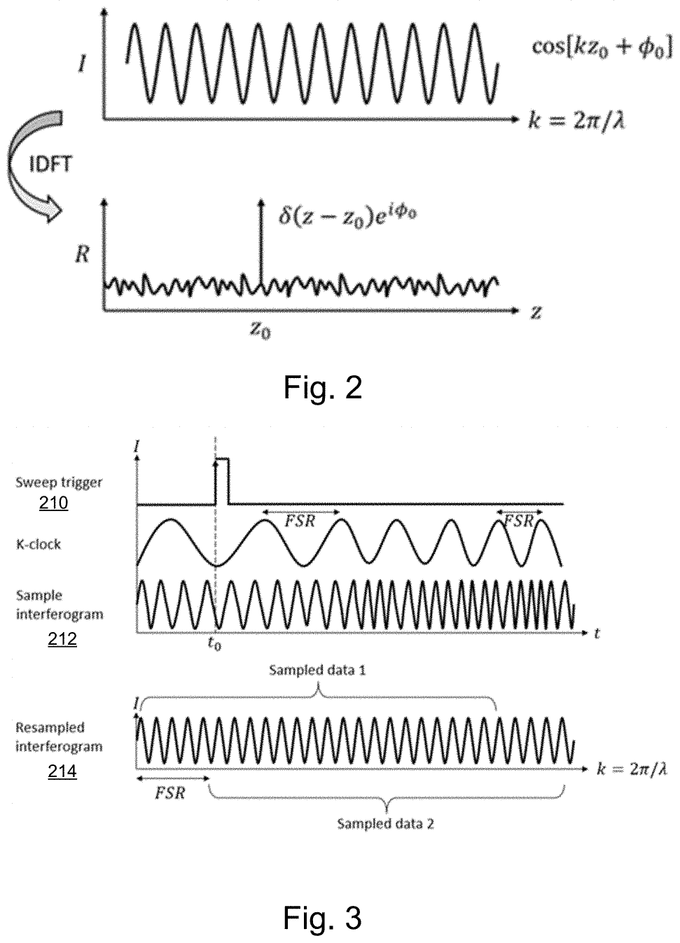

FIG. 2 show how the OCT image processing algorithms executed by the controller 105, for example, include a step where an axial line or A-line is calculated from the inverse Fourier transform of an interferogram vs wave number vector.

In swept source OCT systems, a resampling algorithm is routinely used to convert raw time-domain vectors to vectors that are sampled uniformly in wave number. If the algorithm produces resampled data with uniform wave number sampling but time-varying wave number offsets, the OCT system is said to be “phase unstable”. OCT systems may be characterized by their degree of phase stability using one of several common test methodologies.

Phase-unstable OCT systems can produce B-scans with very good quality metrics such as resolution, contrast and dynamic range. However, there are several features of OCT image processing that require varying degrees of phase stability to perform well. For example, the sidelobe suppression ratio (SRS) of OCT systems is commonly degraded by the presence of“fixed patterns” originating from the laser source or the system interferometer. These fixed patterns can be suppressed through background-subtraction. It can be shown that the performance of background subtraction, especially of patterns deep in the image range, is highly-dependent on the system phase stability.

An entire class of OCT features that require phase stability is those that rely on a set of data vectors collected rapidly in time, such as Doppler OCT and phase-sensitive angiography. In these methods, variations of both amplitude and phase of the complex-valued A-lines are interpreted as local tissue motion, typically attributed to local blood flow. Accurate and sensitive blood flow maps are important in many biomedical imaging contexts as they are viewed as important markers of disease presence or progression. Any phase instability of the OCT system severely reduces the sensitivity and accuracy of these phase-sensitive OCT features.

Popular laser architectures used for swept source OCT is micro-electro-mechanical systems (MEMS)-based Fabry-Perot external cavity lasers, or MEMS-Vertical Cavity Surface Emitting Lasers (MEMS-VCSELs). These architectures produce wavelength sweeps through the motion of a reflector mounted on a MEMS capacitive drive micro-structure. The drive electronics used to control the motion of the MEMS micro-structures is typically arranged to sweep as linearly as possible in wave number over time, and an electronic sweep trigger pulse is provided to mark the start time of each sweep.

Another popular architecture is a laser cavity employing a diffraction grating and a spinning polygonal mirror reflector. In this architecture, the polygonal mirror is arranged to sweep as linearly as possible in wave number over time, and a sweep trigger pulse is provided to mark the start time of each sweep.

Details of the sweep linearity are detected using the clocking system 110, such as the illustrated k-clock reference interferometer, so called because the resulting spectral interferogram phase transitions occur at uniform wave number spacing. For example, samples in time corresponding to zero phase (peaks in the spectral interferogram) are separated by the clock free spectral range (FSR). In OCT systems that use software resampling approaches, the spectral interferogram produced from the k-clock reference interferometer and the spectral interferogram from the sample interferometer are sampled simultaneously for each sweep at a constant sample rate. Then, sample interferogram data vectors are resampled at times corresponding to phase transitions of the k-clock reference interferometer. This produces sample spectral interferograms that are uniformly sampled in wave number, as desired.

A limitation to the software resampling approach is the k-clock reference spectral interferogram has phase ambiguities. First, the wave number corresponding to a spectral interferogram phase transition is dependent on the temperature and strain of the optics comprising the reference interferometer. These thermal effects typically produce a drifting phase offset which change slowly with respect to the timescale of a typical imaging session and are often ignored. Second, the spectral interferogram is a narrow-band signal with two-pi phase ambiguities. These phase ambiguities produce resampled data vectors that have phase offsets of integer multiples of the k-clock FSR.

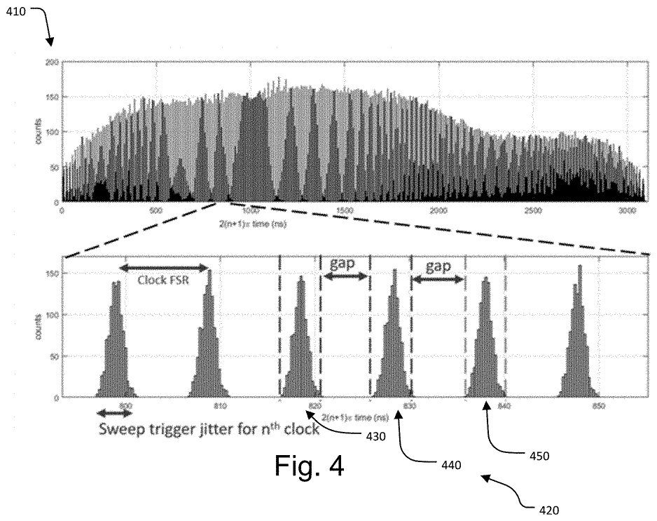

FIG. 3 illustrates this principle.

This shows a simplified OCT software resampling scheme with k-clock errors. The sweep trigger 210 causes the digitizer to begin sampling the k-clock and sample interferograms for a laser sweep at t=t₀. The sample interferogram 212 is interpolated at time points corresponding to uniform phase transitions of the k-clock spectral interferogram (e.g. at ϕ_{n,m}=2πm/M for the m^{th} sample of the n^{th} clock). This results in uniform k-sampling in the resampled interferogram 214. In this example, the naïve phase unwrapping algorithm assigns the k-clock phase at t=t₀ to the range π<ϕ(t₀)<3π for sweep 1 and to the range −π<ϕ(t₀)≤π for sweep 2, resulting in a different portion of the underlying spectral interferogram being sampled and passing to the next step of the signal processing pipeline. The k-sampling shift of one clock FSR results in a phase shift in the A-line result.

The two-pi phase ambiguity is important for systems where the phase instability of the k-clock interferometer is a significant fraction of the clock FSR, and where the time distribution of the pi phase crossings overlaps the sweep trigger position. When these conditions are present, phase offsets of integer multiples of the clock FSR are very likely to be present in the resampled data, and the system will have limited phase stability, with correspondingly poor performance in background subtraction or Doppler or phase-sensitive angiography.

In the present approach, a signal processing algorithm is used to recover phase stability for marginally phase stable systems. That is, systems which are phase unstable using naïve signal processing algorithms but have phase errors which are measurable and correctable through additional processing steps described here.

Background Subtraction

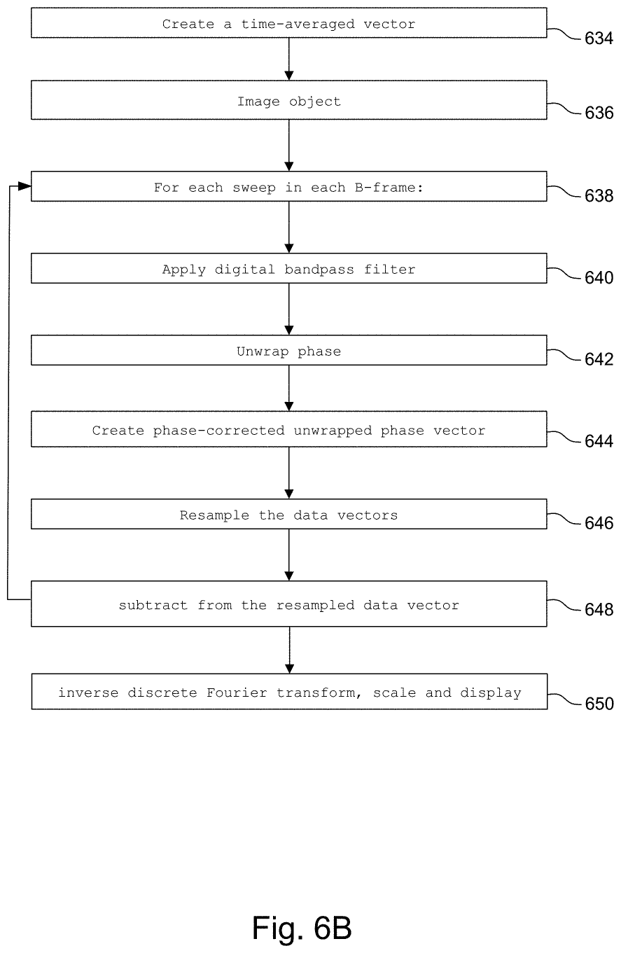

FIG. 6A shows the method described here to specifically implement phase-stable background subtraction.

Send sample arm light to beam dump, acquire background B-frame data in step 610.

Data is N_s×M for N_s samples per A-line sweep and M A-lines per B-frame.

In step 610, apply digital bandpass filter to k-clock spectral interferogram signal to remove unwanted signal contributions (e.g. narrow-band noise power, harmonics from digital clock signal). This step is not always required.

For each sweep in the B-frame, unwrap the phase of the k-clock spectral interferogram signal x[n] using a naïve discrete Hilbert transform method in step 614.

In step 616, apply the discrete Hilbert transform y[n]=H{x[n]} and generate a complex analytic signal z[n]=x[n]+iy[n].

Define a phase vector φ[n]=a tan(y[n]/x[n]) in step 618.

Note that φ[n]∈(−π,π]. The 2π phase ambiguities in the k-clock vector are removed in step 620, creating a phase unwrapped φ\hat{ }[n] to be a monotonic signal with approximate range φ\hat{ }[n]∈[0,2πN_c] for N_c the number of expected sample clocks in the sampled bandwidth.

For each sweep in the B-frame, create a vector of samples numbers {n_π} corresponding to the samples where the phase vector undergoes a phase wrap discontinuity. E.g. where φ[n_π]=π for each of n∈[0,N_c], in step 622.

A histogram of all phase discontinuity samples {n_π} in the B-frame is created in step 624. The expected result is a set of N_c probability density functions of the number of samples from the sweep trigger to the nth clock phase wrap discontinuity.

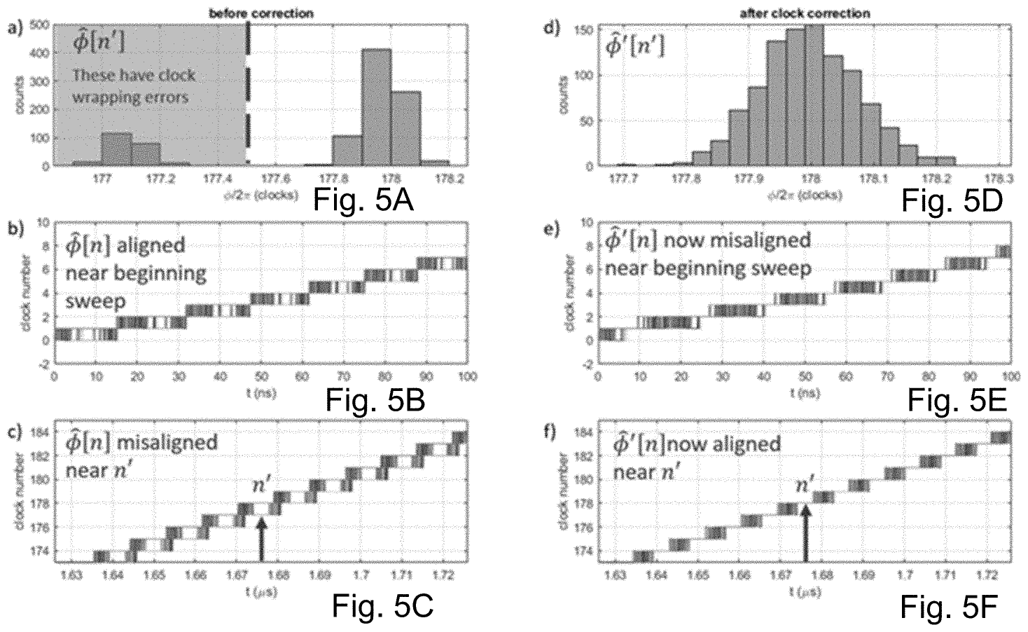

This is shown in FIG. 4.

Here, a histogram 410 of k-clock spectral interferogram phase transition times is shown. This is an aggregate distribution of entire sampled data region. Insert 420 is a zoomed in view of histogram 410 showing the portion of the sweep with highest phase stability. Here the k-clock FSR of 80 GHz separates the clock transitions. Dashed regions 430, 440, and 450 denote the distribution bounds of three consecutive clocks. Non-zero gaps between clock distributions confirms the phase stability of the system is good enough for the phase correction algorithm.

Returning to FIG. 6A, in a perfectly phase-stable OCT system, the histogram will have zero bin counts everywhere except at N_c bins. In a slightly phase-unstable OCT system, there will be N_c distributions with non-zero widths, but no distribution overlaps. In a marginally phase stable system—of interest in this disclosure—the distributions will overlap in some regions and not others. It is the goal of this section to identify the most phase-stable regions and establish an optimally positioned virtual sweep trigger.

Thus, in step 626 the histogram is searched for the center of the widest gap region between clock phase wrap discontinuity distributions. Record the sample n^{∧}′ corresponding to this histogram bin. This is the optimum sample location for a virtual sweep trigger, as it is the expected value of the clock distribution with the most margin from a clock wrapping discontinuity. E.g. it chooses the optimum from the set {n_0} for φ[n_0]=0. Note that this distribution does not need to be calculated.

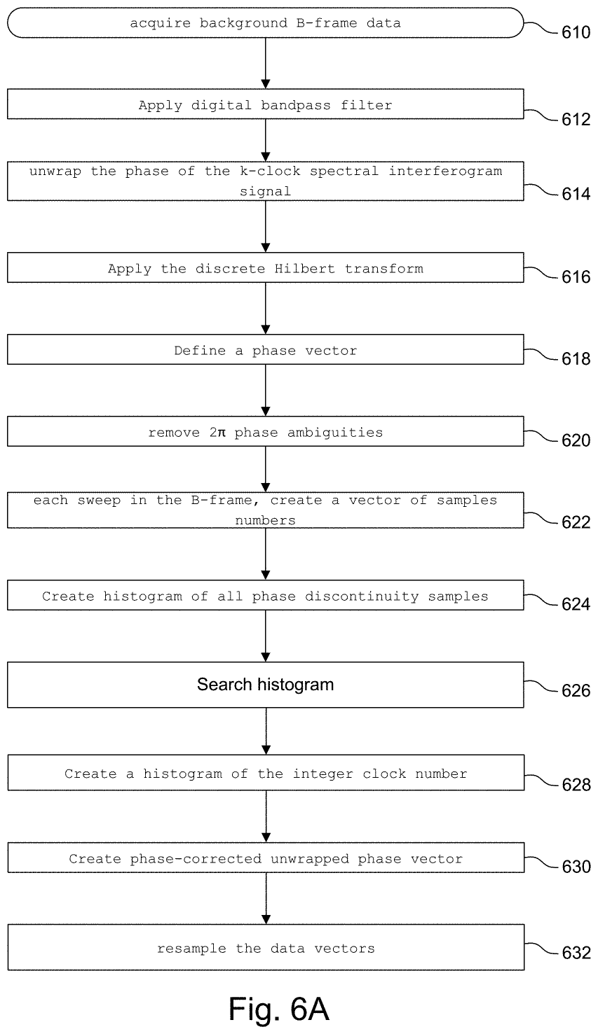

In step 628, a new histogram of the integer clock number is create at the virtual sweep trigger sample └ϕ\hat{ }[n^{∧}′]″+0.5″┘. Denote the bin with the highest counts as the correct clock number, N_c\hat{ }′. See FIG. 5A.

For each sweep in the B-frame, a phase-corrected unwrapped phase vector φ\hat{ }^{∧}′[n]=φ\hat{ }[n]−└φ\hat{ }[n^{∧}′]″+0.5″┘+N_c^{∧}′ is created in step 630. Now the clock unwrapped phase vector has been phase aligned. See FIGS. 5D-F.

For each sweep in the B-frame, resample the data vectors using φ\hat{ }^{∧}′[n] using the standard algorithm in step 632.

The process continues into FIG. 6B where a time-averaged vector “dataBG”[n] by averaging in the resampled k-domain is created in step 634.

Now the sample arm light is sent to object to be imaged, acquire sample data in step 636. The resulting data is N×M×L for L B-frames per imaging session.

For each sweep in each B-frame in step 638 the following step are performed:

In step 640, a digital bandpass filter is applied to k-clock spectral interferogram signal to remove unwanted signal contributions. Use the same filtering as in step 612.

In step 642, the phase of the k-clock spectral interferogram signal x[n] is unwrapped using a naïve discrete Hilbert transform method, as in step 614.

A phase-corrected unwrapped phase vector φ\hat{ }^{∧}′[n]=φ\hat{ }[n]−└ϕ\hat{ }[n^{∧}′]″+0.5″┘+N_c^{∧}′ using n^{∧}′ and N_c^{∧}′ is generated in step 644. This is as calculated in steps 624 and 626. Now the clock unwrapped phase vector has been phase aligned.

Next the data vectors are resampled using φ\hat{ }^{∧}′[n] using the standard algorithm in step 646.

And then subtract from the resampled data vector “dataBG” [n] in step 648.

These steps are repeated for each sweep.

Finally, once all sweeps have been processed, the inverse discrete Fourier transform is performed and the image is scaled and displayed in step 650.

Note that the background subtraction vector dataBG[n] does not necessarily require moving the sample arm power to a beam dump. Other methods, such as averaging data vectors across a B-frame may be used. This technique relies on sample-related interference fringes being reduced in the background data by fringe washout due to sample motion and beam scanning relative to fixed patterns which are more stable. The method disclosed here provides detection, quantification, and correction of laser source phase instabilities using only the k-clock reference signal; the content of the background data is not significant.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for measuring and correcting phase errors in an OCT system, comprising:
find phase stable regions of sweeps; and
for each sweep of an object, unwrap the phase vector based on the phase stable regions of the sweeps.

2. An optical coherence tomography system, comprising:
a sample interferometer;
a digital acquisition system for digitizing sweeps from the sample interferometer;
an image processing computer for taking the sweeps of an object and for each sweep of the object, unwrapping the phase vector based on the phase stable regions of the sweeps.
